(19) United States
(12) Patent Application Publication
(10) Pub. No.: US 2026/0365192 A1
(43) Pub. Date: Nov. 19, 2026

(54) VEHICLE CONTROLLER, A PEDAL MIS-MANIPULATING HANDLING METHOD THEREOF, AND A VEHICLE COMPRISING THE SAME

(71) Applicants: HYUNDAI MOTOR COMPANY, Seoul (KR); KIA CORPORATION, Seoul (KR)

(72) Inventor: Dong Hoon Jeong, Hwaseong-si (KR)

(73) Assignees: HYUNDAI MOTOR COMPANY, Seoul (KR); KIA CORPORATION, Seoul (KR)

(21) Appl. No.: 19/388,141

(22) Filed: Nov. 13, 2025

(30) Foreign Application Priority Data
May 13, 2025 (KR) 10-2025-0062095

(51) Int. Cl. B60W 50/12; B60W 30/09; B60W 40/09

(52) U.S. Cl. CPC B60W 50/12; B60W 30/09; B60W 40/09; B60W 2540/10; B60W 2540/12; B60W 2540/14

(57) ABSTRACT

A vehicle controller includes a communication module configured to communicate based on a vehicle communication network and a processor configured to receive vehicle state data through the communication module, input the vehicle state data to an agent configured to learn to infer pedal mis-manipulation, compare an inference value that is an output of the agent with a predetermined reference value, determine whether pedal mis-manipulation occurs based on a comparison result, and control the vehicle based on the determination of whether pedal mis-manipulation occurs. The agent may include a first agent and a second agent generated by performing competitive multi-agent reinforcement learning, thereby enabling effective pedal mis-manipulation handling adaptable to various driver preferences.

### CROSS-REFERENCE TO THE RELATED APPLICATION

This application claims priority to Korean Patent Application No. 10-2025-0062095 filed on May 13, 2025 in the Korean Intellectual Property Office, the disclosure of which is incorporated herein by reference in its entirety.

### Technical Field

The present disclosure relates to a vehicle controller, and more particularly to technology associated with a vehicle controller configured to perform pedal mis-manipulation determination and a vehicle control based on a method selected according to a user-set level among various pedal mis-manipulation handling methods, a pedal mis-manipulation handling method thereof, and a vehicle comprising the same.

### BACKGROUND

Accidents caused by pedal mis-manipulation represent one type of vehicle accident that can occur when a driver mis-manipulates pedals contrary to their intention. For example, when a driver mistakes an accelerator pedal for a brake pedal and manipulates the accelerator pedal during a sudden braking situation, an accident due to pedal mis-manipulation may occur.

To prevent accidents caused by pedal mis-manipulation, research has been conducted on technology that defines specific conditions and, when the defined specific conditions are satisfied, determines pedal mis-manipulation and prevents sudden acceleration.

However, pedal mis-manipulation determination based on specific conditions fails to appropriately reflect the intentions of drivers with various tendencies (i.e., lacks universality) and may cause other accidents. For example, when a driver manipulates an accelerator pedal for sudden acceleration for overtaking purposes (e.g., 100% manipulation), the accelerator pedal manipulation may correspond to sudden acceleration restriction conditions, resulting in failure to accelerate contrary to the driver's intention, which may cause an accident by a following vehicle.

Therefore, there is a need for a solution that is more effective than conventional pedal mis-manipulation determination methods and can be universally applied to drivers with various tendencies.

The above matters disclosed in this section are merely for enhancement of understanding of the general background of the disclosure and should not be taken as an acknowledgement or any form of suggestion that the matters form the related art already known to those having ordinary skill in the art.

### SUMMARY

Therefore, the present disclosure has been made in view of the above problems, and it is an object of the present disclosure to provide a vehicle controller configured to perform pedal mis-manipulation determination and vehicle control based on a method selected according to a pedal mis-manipulation handling level set by a user among various pedal mis-manipulation handling methods, a pedal mis-manipulation handling method thereof, and a vehicle comprising the same.

It is another object of the present disclosure to provide a vehicle controller configured to perform pedal mis-manipulation determination and vehicle control based on a Q-function and policy of an agent selected according to a pedal mis-manipulation handling level set by a user, a pedal mis-manipulation handling method thereof, and a vehicle comprising the same.

It is yet another object of the present disclosure to provide a vehicle controller configured to determine pedal mis-manipulation based on an output (inference value) of an agent generated by performing competitive multi-agent reinforcement learning on a random learning environment generated based on vehicle surrounding environment data and vehicle state data, a pedal mis-manipulation handling method thereof, and a vehicle comprising the same.

Objects are not limited to the above technical objects, and other technical objects not mentioned should be clearly understood by those having ordinary skill in the art to which the present disclosure belongs from the following description.

The above and other objects can be accomplished by the provision of a vehicle controller according to an embodiment of the present disclosure. In accordance with an aspect of the present disclosure, there is provided a controller provided in a vehicle and configured to control the vehicle, the controller comprising: a communication module configured to communicate based on a vehicle communication network; and a processor. The processor is configured to receive vehicle state data through the communication module, input the vehicle state data to an agent learned to infer pedal mis-manipulation, compare an inference value that is an output of the agent with a predetermined reference value, determine whether pedal mis-manipulation occurs based on a comparison result, and control the vehicle based on the determination of whether pedal mis-manipulation occurs.

According to an embodiment of the present disclosure, the processor may be configured to determine control parameters based on an action of the agent and control the vehicle based on the control parameters, when determining whether pedal mis-manipulation state occurs.

According to an embodiment of the present disclosure, the agent may include a first agent and a second agent generated by performing competitive multi-agent reinforcement learning on a random learning environment generated based on vehicle surrounding data and vehicle state data.

According to an embodiment of the present disclosure, the first agent and the second agent may be learned based on a state-action value function (Q-function).

According to an embodiment of the present disclosure, the first agent and the second agent may be learned based on different policies.

According to an embodiment of the present disclosure, a first policy may be an accident-inducing policy configured to induce a state immediately before a vehicle accident, and a second policy may be an accident-prevention policy configured to restore the state immediately before a vehicle accident to a safe state.

In accordance with another aspect of the present disclosure, there is provided a pedal mis-manipulation handling method of a controller provided in a vehicle, the method comprising: receiving, by a processor of the controller, vehicle state data through a communication module; inputting, by the processor, the vehicle state data to an agent learned to infer pedal mis-manipulation; comparing, by the processor, an inference value that is an output of the agent with a predetermined reference value; determining, by the processor, whether pedal mis-manipulation occurs based on a comparison result; and controlling, by the processor, the vehicle based on the determination of whether pedal mis-manipulation occurs.

In accordance with yet another aspect of the present disclosure, there is provided a vehicle comprising a vehicle controller, wherein the vehicle controller includes: a communication module configured to communicate based on a vehicle communication network; and a processor. The processor is configured to receive vehicle state data through the communication module, input the vehicle state data to an agent learned to infer pedal mis-manipulation, compare an inference value that is an output of the agent with a predetermined reference value, determine whether pedal mis-manipulation occurs based on a comparison result, and control the vehicle based on the determination of whether pedal mis-manipulation occurs. Accordingly, embodiments of the present disclosure can provide a vehicle controller configured to perform pedal mis-manipulation determination and vehicle control based on a method selected according to a pedal mis-manipulation handling level set by a user among various pedal mis-manipulation handling methods. In addition, since agents can be selected according to the pedal mis-manipulation handling level from an accident-inducing learning agent group including a plurality of accident-inducing agents learned to have different accident induction rates and an accident-prevention learning agent group including a plurality of accident-prevention agents learned to have different accident prevention rates, pedal mis-manipulation handling can be actively adjusted according to the pedal mis-manipulation handling level selected by the user. Therefore, the pedal mis-manipulation handling method according to embodiments of the present disclosure is more effective than conventional pedal mis-manipulation determination methods and can be universally applied to drivers with various tendencies.

### BRIEF DESCRIPTION OF THE DRAWINGS

The above and other objects, features and other advantages of the present disclosure should be more clearly understood from the following detailed description taken in conjunction with the accompanying drawings.

FIG. 1 is a view showing a vehicle 1 provided with a vehicle controller according to an embodiment of the present disclosure.

FIG. 2 is a view illustrating an example configuration of a sensor group according to an embodiment of the present disclosure.

FIG. 3 is a view depicting an example configuration of a driving controller according to an embodiment of the present disclosure.

FIG. 4 is a view presenting an example configuration of a vehicle controller according to an embodiment of the present disclosure.

FIG. 5 is a view explaining a pedal mis-manipulation handling operation of the vehicle controller according to an embodiment of the present disclosure.

FIG. 6 is a view showing an example configuration of an apparatus for learning an agent according to an embodiment of the present disclosure.

FIG. 7 is a view describing a process of learning an agent according to an embodiment of the present disclosure.

### DETAILED DESCRIPTION OF THE EMBODIMENTS

Hereinafter, embodiments of the present disclosure are described in detail with reference to the accompanying drawings. In the drawings, the same or similar elements are designated by the same reference numerals regardless of the figure numbers, and redundant description thereof will be omitted.

In describing the embodiments disclosed in the present specification, when it is determined that detailed descriptions of related known technologies may obscure the gist of the embodiments disclosed in the present specification, the detailed descriptions thereof have been omitted. In addition, the accompanying drawings are only for easy understanding of the embodiments disclosed in the present specification, and the technical spirit disclosed in the present specification is not limited by the accompanying drawings, and should be understood to include all changes, equivalents, and substitutes included in the spirit and technical scope of the present disclosure.

Terms including ordinal numbers such as first and second may be used to describe various components, but the components are not limited by the terms. The terms are used only for the purpose of distinguishing one component from another component.

Singular expressions include plural expressions unless the context clearly indicates otherwise.

In the present specification, terms such as “comprise,” “include” or “have” are intended to designate that a feature, number, step, operation, component, part, or combination thereof described in the specification exists, and should be understood as not precluding the existence or addition possibility of one or more other features, numbers, steps, operations, components, parts, or combinations thereof.

The suffixes “module” and “unit” for components used in the following description are given or used interchangeably only in consideration of ease of specification preparation, and do not have meanings or roles that are distinguished from each other. When a component, module, unit, controller, device, element, apparatus, or the like of the present disclosure is described as having a purpose or performing an operation, function, or the like, the component, module, unit, controller, device, element, apparatus, or the like should be considered herein as being “configured to” meet that purpose or to perform that operation or function. Each component, module, unit, controller, device, element, apparatus, and the like may separately embody or be included with a processor and a memory, such as a non-transitory computer readable media, as part of the apparatus. The memory may be configured to store computer-executable instructions, and the processor may be configured to execute the computer-executable instructions to perform the operation or function associated therewith.

When a component is referred to as being “connected” or “coupled” to another component, it should be understood that it may be directly connected or coupled to the other component, but other components may exist in between. On the other hand, when a component is referred to as being “directly connected” or “directly coupled” to another component, it should be understood that no other components exist in between.

Additionally, the unit or control unit included in the name is only a term widely used in naming a controller that controls specific vehicle functions, and does not mean a generic function unit.

A controller may include a communication device that communicates with other controllers or sensors for control of the responsible function, a memory that stores an operating system, logic commands, input/output information, and the like, and one or more processors that perform judgments, calculations, decisions, and the like necessary for responsible function control.

Any number of components or various components among the configurations described in the present specification may be included within the disclosure described in the present specification. The components may include any combination of the features described in the present specification and may be arranged in any configuration among the various configurations described in the present specification.

Various embodiments having various features of various arrangements including those are described below with reference to the drawings.

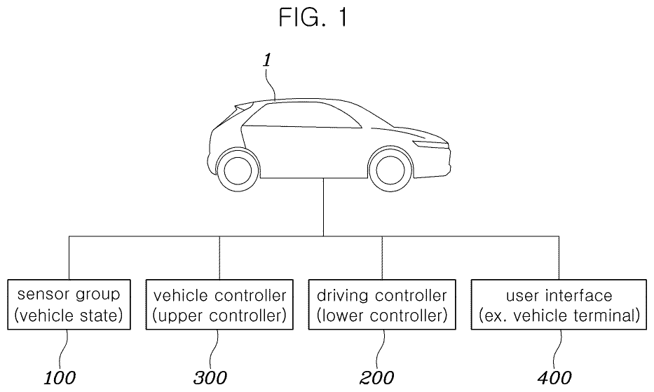

Referring to FIG. 1, the vehicle 1 may include a sensor group 100, a driving controller 200, and a vehicle controller 300. The configuration of the vehicle 1 is not limited thereto.

According to an embodiment of the present disclosure, the vehicle 1 may be an electrified vehicle including a motor as a power source. For example, the vehicle 1 may be an eco-friendly vehicle such as an Electric Vehicle (EV), a Hybrid Electric Vehicle (HEV), a Plug-in Hybrid Electric Vehicle (PHEV), or a Fuel Cell Electric Vehicle (FCEV).

The sensor group 100, the driving controller 200, and the vehicle controller 300 may communicate with each other based on a vehicle communication network. For example, the vehicle communication network may include Local Interconnect Network (LIN), Controller Area Network (CAN), Media Oriented Systems Transport (MOST) network, FlexRay, Ethernet, and the like, but the type of vehicle communication network is not limited thereto.

According to an embodiment of the present disclosure, the vehicle 1 may further include a user interface 400. For example, the user interface 400 may be a vehicle terminal, but the type of user interface 400 is not limited thereto. For example, the user interface 400 may communicate with the vehicle controller 300 based on a vehicle communication network. For example, the user interface 400 may provide pedal mis-manipulation handling level information input (or set) by a user to the vehicle controller 300.

The sensor group 100 may sense state data of the vehicle 1 and output vehicle state data to the vehicle controller 300.

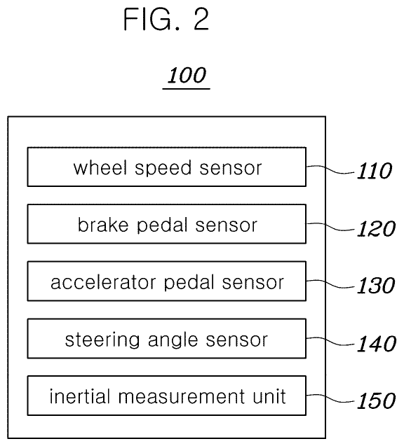

Referring to FIG. 2, the sensor group 100 may include a wheel speed sensor 110, a brake pedal sensor 120, an accelerator pedal sensor 130, a steering angle sensor 140, an inertial measurement unit 150, and the like, but the types of sensors included in the sensor group 100 are not limited thereto.

The wheel speed sensor 110 may be installed on wheels of the vehicle 1 to detect wheel speed of each wheel and output the wheel speed to the vehicle controller 300.

The brake pedal sensor (BPS) 120 may detect a position of a brake pedal of the vehicle 1 and output the position to the vehicle controller 300.

The accelerator pedal sensor (APS) 130 may detect a position of an accelerator pedal of the vehicle 1 and output the position to the vehicle controller 300.

The steering angle sensor 140 may be connected to a steering wheel to detect a steering angle and output the steering angle to the vehicle controller 300.

The inertial measurement unit (IMU) 150 may measure speed, direction, gravity, acceleration and/or angular velocity of the vehicle 1 and output the measurements to the vehicle controller 300.

For example, the inertial measurement unit 150 may include an acceleration sensor capable of measuring acceleration in vertical, lateral and/or longitudinal directions and an angular velocity sensor capable of measuring angular velocities of roll rate, pitch rate, and/or yaw rate.

The driving controller 200 may control driving (e.g., acceleration, braking and/or steering, and the like) of the vehicle 1 based on control of the vehicle controller 300. The driving controller 200 may be a lower controller that operates according to control of the vehicle controller 300.

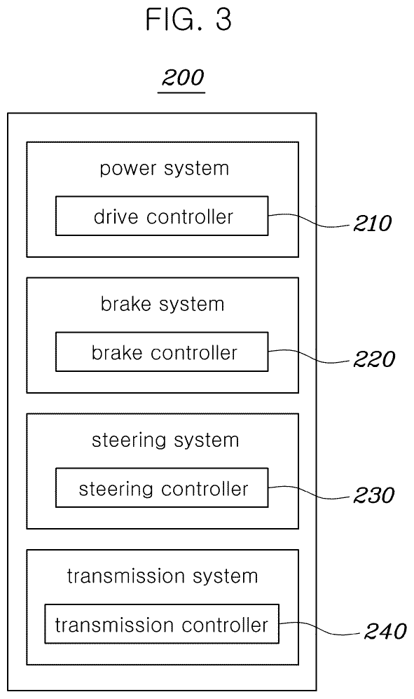

Referring to FIG. 3, the driving controller 200 may include a drive controller 210, a brake controller 220, a steering controller 230, and a transmission controller 240.

For example, the drive controller 210, the brake controller 220, the steering controller 230, and the transmission controller 240 may be implemented as Electronic Control Units (ECUs). The electronic control unit may include a memory storing software programmed to perform predetermined functions (operations), a processor executing the software stored in the memory, and a communication module including circuits for communicating with other controllers and/or sensors within the vehicle.

The drive controller 210 constitutes a power system of the vehicle 1 and may control a power source (e.g., engine and/or drive motor, and the like) of the vehicle 1. The drive controller 210 may control output (e.g., output torque) of the power source according to accelerator pedal position information or required driving speed (speed command) of the vehicle controller 300. For example, the drive controller 210 may include an Engine Management System (EMS) and/or a Motor Control Unit (MCU).

The brake controller 220 constitutes a brake system of the vehicle 1 and is configured to control deceleration (braking) of the vehicle 1, and may control braking force of the vehicle 1 based on brake pedal position or required braking force of the vehicle controller 300. For example, the brake controller 220 may include Electronic Stability Control (ESC).

The steering controller 230 constitutes a steering system of the vehicle 1 and may control steering of the vehicle 1. The steering controller 230 may include Motor Drive Power Steering (MDPS) and may adjust a steering angle of the vehicle 1 according to instructions of the vehicle controller 300.

The transmission controller 240 constitutes a transmission system of the vehicle 1 and may control a transmission of the vehicle 1 according to instructions of the vehicle controller 300. The transmission controller 240 may adjust a gear ratio according to gear position and/or gear state range. For example, the transmission controller 240 may be implemented as a Transmission Control Unit (TCU).

The vehicle controller 300 may control driving of the vehicle 1 by controlling the driving controller 200 based on vehicle state data provided from the sensor group 100.

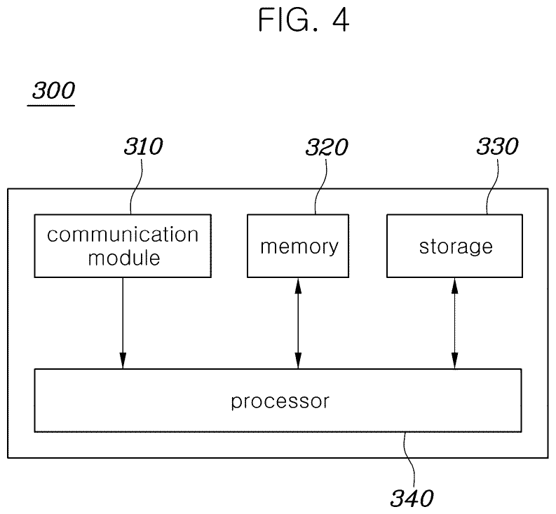

Referring to FIG. 4, the vehicle controller 300 may include a communication module 310, a memory 320, a storage 330, and a processor 340, but the configuration of the vehicle controller 300 is not limited thereto.

The communication module 310 may include communication circuits configured to communicate with the sensor group 100, the driving controller 200, and the user interface 400 based on a predetermined vehicle communication network.

Information received by the communication module 310 may be stored in the memory 320, stored in the storage 330, and transmitted to the processor 340.

The memory 320 may store algorithms (or software or programs), data, and the like, necessary for performing functions of the vehicle controller 300.

For example, the memory 320 may store algorithms, data, and the like, necessary for the vehicle controller 300 to perform pedal mis-manipulation determination and vehicle control based on vehicle state data of the sensor group 100. According to an embodiment of the present disclosure, the memory 320 may store an accident-inducing learning agent group including a plurality of accident-inducing agents that are neural network models learned to have different accident induction rates, and a plurality of accident-prevention agents that are neural network models learned to have different accident prevention rates according to an embodiment of the present disclosure.

The storage 330 may store information generated or acquired according to operation of the vehicle controller 300. For example, the storage 330 may store vehicle state data provided from the sensor group 100, state data of the driving controller 200, and the like.

For example, the memory 320 and the storage 330 may be implemented as at least one storage medium among storage media such as flash memory, hard disk, Secure Digital Card (SD card), Random Access Memory (RAM), Static Random Access Memory (SRAM), Read Only Memory (ROM), Programmable Read Only Memory (PROM) , Electrically Erasable and Programmable ROM (EEPROM), Erasable and Programmable ROM (EPROM), registers, removable disks, and web storage.

The processor 340 may perform overall operations of the vehicle controller 300. For example, the processor 340 may determine pedal mis-manipulation based on information or signals received through the communication module 310, algorithms/data stored in the memory 320, information stored in the storage 330, and the like, and may control the driving controller 200 according to a corresponding strategy.

To this end, the processor 340 may be a data processing device implemented in hardware having circuits with physical structures for executing desired operations. For example, the desired operations may include code or instructions included in a program. For example, the data processing device implemented in hardware may include a microprocessor, central processing unit, processor core, multi-core processor, multiprocessor, Application-Specific Integrated Circuit (ASIC), Field Programmable Gate Array (FPGA).

According to an embodiment of the present disclosure, the processor 340 may perform pedal mis-manipulation determination and vehicle control based on a method selected according to a pedal mis-manipulation handling level set by a user among various pedal mis-manipulation handling methods.

According to an embodiment of the present disclosure, the processor 340 may perform pedal mis-manipulation determination and vehicle control based on a Q-function and policy of an agent selected according to a pedal mis-manipulation handling level set by a user.

According to an embodiment of the present disclosure, the processor 340 may determine pedal mis-manipulation based on an output (inference value) of an agent generated by performing competitive multi-agent reinforcement learning on a random learning environment generated based on vehicle surrounding environment data (i.e., data of the surrounding environment of the vehicle) and vehicle state data.

According to an embodiment of the present disclosure, the processor 340 may determine pedal mis-manipulation by selecting an agent according to a pedal mis-manipulation handling level from an accident-inducing learning agent group including a plurality of accident-inducing agents learned to have different accident induction rates and an accident-prevention learning agent group including a plurality of accident-prevention agents learned to have different accident prevention rates.

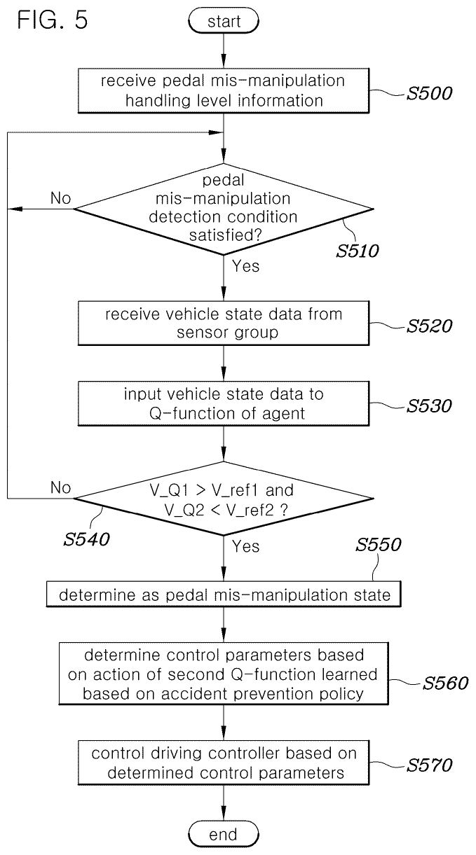

Referring to FIG. 5, the vehicle controller 300 may receive pedal mis-manipulation handling level information provided from the user interface 400 in step S500. According to an embodiment of the present disclosure, the vehicle controller 300 may not receive pedal mis-manipulation handling level information.

When the vehicle controller 300 receives pedal mis-manipulation handling level information, the vehicle controller 300 may determine an agent corresponding to the pedal mis-manipulation handling level information from an accident-inducing learning agent group and an accident-prevention learning agent group stored in a storage device (memory or storage), and may operate based on the determined agent.

On the other hand, when the vehicle controller 300 does not receive pedal mis-manipulation handling level information, the vehicle controller 300 may operate based on a predetermined agent.

According to an embodiment of the present disclosure, the vehicle controller 300 may include an accident-inducing learning agent group including a plurality of accident-inducing agents learned to have different accident induction rates, and an accident-prevention learning agent group including a plurality of accident-prevention agents learned to have different accident prevention rates.

In this example, each agent may be a reinforcement learning neural network model generated by performing competitive multi-agent reinforcement learning on a random learning environment generated based on vehicle surrounding environment data and vehicle state data.

According to an embodiment of the present disclosure, each accident-inducing agent is learned based on a Q-function (or state-action value function), learned based on a policy (accident-inducing policy) configured to induce a state immediately before a vehicle accident, and may output an inference value corresponding to an accident induction rate.

Each accident-inducing agent may be composed of a Q-function and a policy. Hereinafter, the Q-function and policy (π) of the accident-inducing agent are referred to as a first Q-function (Q1) and a first policy (π1).

When the inference value (i.e., accident induction rate) of the accident-inducing agent is low, pedal mis-manipulation detection conditions may be relaxed, and when the inference value (i.e., accident induction rate) of the accident-inducing agent is high, pedal mis-manipulation detection conditions may be strengthened.

According to an embodiment of the present disclosure, each accident-prevention agent is learned based on a Q-function (or state-action value function), learned based on a policy (accident-prevention policy) configured to restore a state immediately before a vehicle accident to a safe state, and may output inference value corresponding to an accident prevention rate.

Each accident-prevention agent may be composed of a Q-function and a policy. Hereinafter, the Q-function (Q) and policy (π) of the accident-prevention agent are referred to as a second Q-function (Q2) and a second policy (π2).

When the accident prevention rate (inference value) is low, passive response to pedal mis-manipulation may be performed, and when the accident prevention rate (inference value) is high, active response to pedal mis-manipulation may be performed.

The vehicle controller 300 determines whether a condition for detecting pedal mis-manipulation (pedal mis-manipulation detection condition) is satisfied in step S510, and when the pedal mis-manipulation detection condition is satisfied (S510-Yes), may perform a pedal mis-manipulation handling operation according to an embodiment of the present disclosure.

According to an embodiment of the present disclosure, the vehicle controller 300 may not perform the operation of determining whether the pedal mis-manipulation detection condition is satisfied in step S510. In other words, the pedal mis-manipulation detection condition may not be satisfied in step S510.

When the vehicle controller 300 performs the pedal mis-manipulation handling operation when the pedal mis-manipulation detection condition is satisfied, resource waste and burden of the vehicle controller 300 can be reduced by preventing performing the pedal mis-manipulation handling operation in unnecessary situations.

For example, the vehicle controller 300 may determine that the pedal mis-manipulation detection condition is satisfied when there is no abnormality in sensors and systems based on sensor signals of sensors and systems within the vehicle 1 and the gear is not in a parked (P) gear and a neutral (N) gear, but the pedal mis-manipulation detection condition is not limited thereto.

When the pedal mis-manipulation detection condition is satisfied (S510-Yes), the vehicle controller 300 receives vehicle state data output from the sensor group 100 in step S520, and may input the received vehicle state data to a Q-function of a determined or predetermined agent in step S530.

For example, the vehicle controller 300 may process vehicle state data into the same form as data used in the process of learning the agent, and then input the processed vehicle state data to the Q-function of the agent.

According to an embodiment of the present disclosure, the Q-function may include a first Q-function (Q1) learned based on a policy configured to induce accident induction and a second Q-function (Q2) learned based on a policy configured to induce accident prevention.

Accordingly, when vehicle state data is input to the Q-function, the first Q-function and the second Q-function may each output an inference value (or value). For example, the inference value (or value) output by the first Q-function may be called a first inference value (or first value) (V_Q1), and the inference value (or value) output by the second Q-function may be called a second inference value (or second value) (V_Q2).

The vehicle controller 300 may determine whether the first inference value (V_Q1) output from the first Q-function and the second inference value (V_Q2) output from the second Q-function satisfy a predetermined pedal mis-manipulation condition in step S540.

According to an embodiment of the present disclosure, the vehicle controller 300 may determine whether the first inference value (V_Q1) is greater than a predetermined first reference value (V_ref1) and the second inference value (V_Q2) is less than a predetermined second reference value (V_ref2).

In this example, the first reference value (V_ref1) and the second reference value (V_ref2) are set as comparison criteria for the first inference value (V_Q1) and the second inference value (V_Q2) to determine pedal mis-manipulation, and may be variously set according to system specifications or applications.

When the first inference value (V_Q1) and the second inference value (V_Q2) satisfy the predetermined pedal mis-manipulation condition (S540-Yes), the vehicle controller 300 may determine a pedal mis-manipulation state in step S550.

According to an embodiment of the present disclosure, the vehicle controller 300 may determine a pedal mis-manipulation state when the first inference value (V_Q1) is greater than the predetermined first reference value (V_ref1) and the second inference value (V_Q2) is less than the predetermined second reference value (V_ref2).

When the first inference value (V_Q1) and the second inference value (V_Q2) do not satisfy the predetermined pedal mis-manipulation condition (S540-No), the vehicle controller 300 may perform operation S510.

According to an embodiment of the present disclosure, when determining a pedal mis-manipulation state, the vehicle controller 300 may determine control parameters for controlling the driving controller 200 based on an action of the second Q-function (Q2) learned based on a policy configured to induce accident prevention in step S560, and may control the driving controller 200 based on the determined control parameters in step S570.

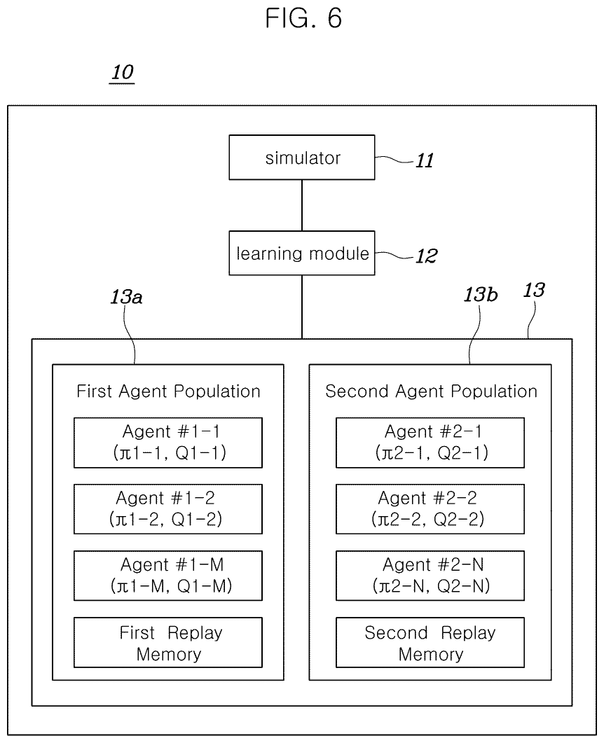

Referring to FIG. 6, an agent learning apparatus 10 may include a simulator 11, a learning module 12, and a memory 13.

The simulator 11 may generate a random learning environment and determine a scenario according to a request of the learning module 12.

For example, the simulator 11 may include a scenario generator, a vehicle model, and a (virtual) surrounding environment. For example, a scenario may be static objects such as buildings and roads, time, weather, road surface conditions, and the like. For example, the surrounding environment may include objects and animals that move by themselves or are moved during an accident, and may be composed of a predefined finite number of types with random parameters such as dimensions and weight. For example, the vehicle model has random parameters such as weight and drive type, and may include an accelerator pedal, brake pedal, steering device, and the like manipulated by an agent. For example, initial states such as positions and velocities of the surrounding environment and vehicle model may be set under control of the learning module 12 or set randomly.

The learning module 12 may request generation of a random learning environment from the simulator 11 and may command the start of a scenario. The learning module 12 may select a first agent or a second agent according to a situation and may transmit an action of the selected agent to the vehicle model of the simulator 11.

In addition, the learning module 12 may collect signals (vehicle sensor signals) measured by vehicle sensors from the simulator 11 and may feed back vehicle sensor signals together with rewards to the selected agent.

The learning module 12 may train a policy (π1) and Q-function (Q1) of the selected first agent and a policy (π2) and Q-function (Q2) of the selected second agent during scenario progress or at the end.

The learning module 12 repeats M*N times by matching M first agents and N second agents once for the same scenario. The learning module 12 may store (s, a, r, s′) tuples generated for one scenario in a replay memory area and reuse them in subsequent learning.

The learning module 12 may determine rankings for M first agents based on a sum (score) of rewards received by each first agent, and similarly, may determine rankings for N second agents based on a sum (score) of rewards received by each second agent. The learning module 12 may replace lower specific % (e.g., 20%) agents with upper specific % (e. g., 20%) agents.

The memory 13 may include a first agent group area 13a including a plurality of first agents and a first replay memory area, and a second agent group area 13b including a plurality of second agents and a second replay memory area.

Each agent may be composed of a policy (π: π1−1~π1−M, π2−1~π2−N) and a Q-function (Q: Q1−1~Q1−M, Q2−1~Q2−N), and may adjust and learn the vehicle model to maximize the sum of rewards received through the learning module 12. For example, the first agent may be learned to induce the vehicle model to a state immediately before an accident, and the second agent may be learned to restore the vehicle model from a state immediately before an accident to a safe state, and the first agent and the second agent are in a competitive relationship where their rewards vary according to each other's policies.

In learning according to an embodiment of the present disclosure, a plurality of first agents and a plurality of second agents are configured, and the plurality of first agents and the plurality of second agents may perform competitive multi-agent reinforcement learning in a random learning environment.

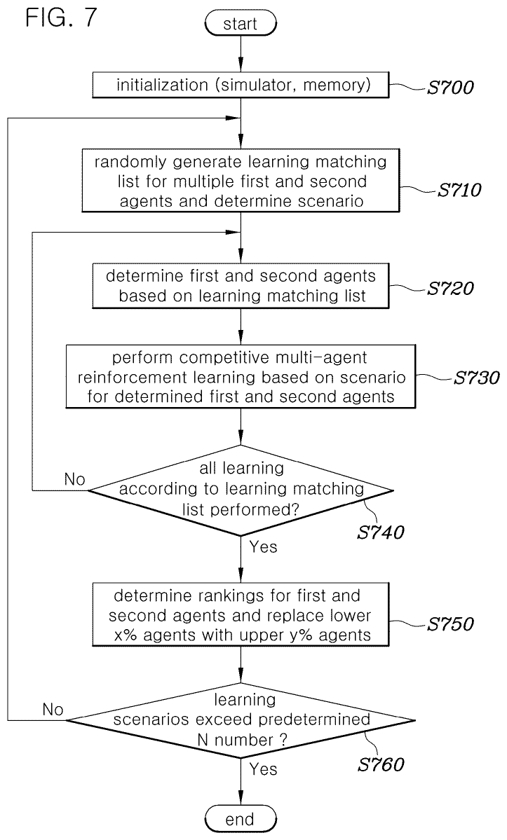

Referring to FIGS. 6 and 7, before learning agents, initialization of the simulator 11 and memory 13 may be performed in step S700.

According to a request of the learning module 12, the simulator 11 may randomly generate a learning matching list for a plurality of first agents and a plurality of second agents and may generate a scenario in step S710.

Subsequently, the learning module 12 determines a first agent and a second agent based on the learning matching list generated by the simulator 11 in step S720, and may perform competitive multi-agent reinforcement learning based on a scenario for the determined first and second agents in step S730.

According to an embodiment of the present disclosure, the first agent may be learned based on a policy (accident-inducing policy) configured to induce a state immediately before a vehicle accident, and the second agent may be learned based on a policy (accident-prevention policy) configured to restore a state immediately before a vehicle accident to a safe state.

In step S730, according to learning performance of the learning module 12, when the first agent performs driving control for the vehicle model, Time to Collision (TTC) is estimated, and when the TTC value is below a predetermined threshold, control authority for the vehicle model may be transferred to the second agent.

Accordingly, the second agent may perform driving control for the vehicle model by changing (or correcting) vehicle control parameters.

When an accident occurs after driving control by the second agent, a reward may be given to the first agent, and when an accident does not occur after driving control by the second agent, a reward may be given to the second agent.

The learning module 12 may store (s, a, r, s′) tuples generated during learning in a replay memory area.

After completing learning for the determined first and second agents, the learning module 12 may determine whether all learning according to the learning matching list has been performed in step S740.

When there is unperformed learning (S740-No), the learning module 12 may determine first and second agents for learning based on the learning matching list in step S720.

When all learning according to the learning matching list has been performed (S740-Yes), the learning module 12 may determine rankings for the first and second agents and replace lower x % agents with upper y % agents in step S750.

In this example, x and y may be variously set according to systems and applications, and x and y may be the same value or different values.

Subsequently, the learning module 12 determines whether learning scenarios have exceeded a predetermined N number in step S760, and when learning scenarios have exceeded the predetermined N number (S760-Yes), may terminate learning for agents.

When learning scenarios have not exceeded the predetermined N number (S760-No), the learning module 12 may request scenario and learning matching list generation from the simulator 11, so that the simulator 11 may randomly generate a learning matching list for a plurality of first agents and a plurality of second agents and generates a scenario in step S710.

Although specific embodiments related to the present disclosure have been shown and described, it should be apparent to those having ordinary skill in the art that various modifications and changes can be made without departing from the technical spirit of the present disclosure provided by the following claims.

What is claimed is:

1. A controller provided in a vehicle and configured to control the vehicle, the controller comprising:
a communication module configured to communicate based on a vehicle communication network; and
a processor configured to:
receive vehicle state data through the communication module,
input the vehicle state data to an agent configured to learn to infer pedal mis-manipulation,
compare an inference value that is an output of the agent with a predetermined reference value,
determine whether pedal mis-manipulation occurs based on a comparison result, and
control the vehicle based on the determination of whether pedal mis-manipulation occurs.

2. The controller of claim 1, wherein the processor is configured to determine control parameters based on an action of the agent and control the vehicle based on the control parameters, based determining whether pedal mis-manipulation state occurs.

3. The controller of claim 1, wherein the agent includes a first agent and a second agent generated by performing competitive multi-agent reinforcement learning on a random learning environment generated based on vehicle surrounding data and vehicle state data.

4. The controller of claim 3, wherein the first agent and the second agent are learned based on a state-action value function (Q-function).

5. The controller of claim 3, wherein the first agent and the second agent are learned based on different policies.

6. The controller of claim 5, wherein a first policy is an accident-inducing policy configured to induce a state immediately before a vehicle accident, and a second policy is an accident-prevention policy configured to restore the state immediately before a vehicle accident to a safe state.

7. The controller of claim 6, wherein the processor is configured to determine control parameters based on an action of the second agent learned based on the second policy and control the vehicle based on the control parameters, based on determining whether pedal mis-manipulation state occurs.

8. The controller of claim 3, wherein the processor is configured to determine whether pedal mis-manipulation occurs by comparing a first inference value that is an output of the first agent and a second inference value that is an output of the second agent with a predetermined first reference value and a predetermined second reference value, respectively.

9. The controller of claim 8, wherein the processor is configured to determine occurrence of pedal mis-manipulation based on the first inference value being greater than the first reference value and the second inference value being less than the second reference value.

10. The controller of claim 1, further comprising:
memory configured to store a first agent group including a plurality of first agents learned based on a first policy and a second agent group including a plurality of second agents learned based on a second policy,
wherein the agent includes one of the plurality of first agents and one of the plurality of second agents.

11. The controller of claim 10, wherein the processor is configured to receive pedal mis-manipulation handling level information and determine one of the plurality of first agents and one of the plurality of second agents based on the pedal mis-manipulation handling level.

12. The controller of claim 10, wherein the plurality of first agents are learned to have different accident induction rates based on the first policy, and the plurality of second agents are learned to have different prevention rates based on the second policy.

13. The controller of claim 1, wherein the processor is configured to receive the vehicle state data based on a pedal mis-manipulation detection condition being satisfied.

14. The controller of claim 13, wherein the processor is configured to determine that the pedal mis-manipulation detection condition is satisfied based on no abnormality in sensors and systems within the vehicle and a gear not being in a P gear and an N gear.

15. A pedal mis-manipulation handling method of a controller provided in a vehicle, the method comprising:
receiving, by a processor of the controller, vehicle state data through a communication module;
inputting, by the processor, the vehicle state data to an agent learned to infer pedal mis-manipulation;
comparing, by the processor, an inference value that is an output of the agent with a predetermined reference value;
determining, by the processor, whether pedal mis-manipulation occurs based on a comparison result; and
controlling, by the processor, the vehicle based on the determination of whether pedal mis-manipulation occurs.

16. The method of claim 15, wherein controlling the vehicle includes determining, by the processor, control parameters based on an action of the agent and controlling the vehicle based on the control parameters, based on determining whether pedal mis-manipulation state occurs.

17. The method of claim 15, wherein the agent includes a first agent and a second agent generated by performing competitive multi-agent reinforcement learning based on different policies.

18. The method of claim 17, wherein comparing the inference value that is the output of the agent with the predetermined reference value includes comparing, by the processor, a first inference value that is an output of the first agent and a second inference value that is an output of the second agent with a predetermined first reference value and a predetermined second reference value.

19. A vehicle comprising:
a vehicle controller, wherein the vehicle controller includes:
a communication module configured to communicate based on a vehicle communication network; and
a processor configured to:
receive vehicle state data through the communication module,
input the vehicle state data to an agent learned to infer pedal mis-manipulation,
compare an inference value that is an output of the agent with a predetermined reference value,
determine whether pedal mis-manipulation occurs based on a comparison result, and
control the vehicle based on the determination of whether pedal mis-manipulation occurs.

20. The vehicle of claim 19, further comprising:
a sensor group connected to the vehicle communication network and configured to provide the vehicle state data; and
driving controller configured to operate under control of the vehicle controller to control driving of the vehicle.
